(19) United States
(12) Patent Application Publication
(10) Pub. No.: US 2004/0154984 A1
(43) Pub. Date: Aug. 12, 2004

(54) Solid material dissolution apparatus

(76) Inventors: Eitan Dafny, Kiryat Ala (IL); Ronen Shechter, Tivon (IL); Rami Pedahzur, Harei Yehuda (IL); David Feldman, Haifa (IL)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/473,779

(22) PCT Filed: Apr. 1, 2002
(86) PCT No.: PCT/IL02/00269

(30) Foreign Application Priority Data
Apr. 2, 2001 (IL) 142389

(51) Int. Cl. B01D 11/04

(52) U.S. Cl. 210/634; 210/764; 210/96.1; 210/97; 422/264

(57) ABSTRACT

According to the present invention a new device is provided for preparing biocide solutions of constant concentrations. More specifically, solid biocide is dissolved, in a controlled and monitored way, to provide solutions, all having the same and constant dose of biocide per volume. The new device overcomes the main disadvantage of the existing solid-biocide feeders, namely the decrease in the biocide concentration with time due to the gradual depletion of solid biocide in the feed container.

### FIELD OF THE INVENTION

According to the present invention a new apparatus is provided for dissolution of a particulate material, preferably a biocide, for preparing a solution of constant concentration. More specifically solid biocide is dissolved, in a controlled and monitored way, to provide solutions, all having the same and constant dose of biocide per volume.

### BACKGROUND OF THE INVENTION

At present, the application of biocidal materials is the most cost-effective means of maintaining the appropriate level of microbiological quality of both industrial and recreational water systems (such as, for example, cooling towers, the pulp and paper industry, swimming pools, etc.). However, due to the hazardous nature of these materials, there has been a growing consideration and emphasis in industry regarding personnel safety, maintaining and handling of such materials and their environmental effects. This led to a demand for new approaches of producing and handling the solutions of these biocides and using highly controlled methods of treatment. A prominent disadvantage associated with applying solid biocide based solutions derived from the inconsistency in biocide concentrations. In other words, the current methods for preparation of biocide solutions suffer from the phenomena that biocide concentrations fall gradually and continuously. This phenomenon is clearly demonstrated in Example 1.

Very commonly, the application of biocides into the treated water is based on a calculated dosage. This is especially true in the application of non-oxidative biocides in which their detection in the aqueous solution is complex and impractical for field application. Especially in these cases the ability to produce a solution with a constant concentration of the biocide is essential and this is a main disadvantage of the existing feeding systems.

An additional major advantage of applying aqueous solutions of biocides is the elimination of organic solvents. Liquid formulation, which contains a mixture of water and an organic solvent such as a glycol, (for example, polyethylene glycol (PEG), dipropylene glycol (DPG), ethylene glycol, etc.) and others are required for dissolution of relatively water-insoluble biocides. The active ingredient (such as 2,2 Dibromo-3-nitrilopropionamide (DBNPA)) might be only 5-25% of such liquid formulation, consisting of water and an organic solvent.

The addition of the organic solvent makes the dissolution process more complicated and expensive and promotes unnecessary addition of organic materials into the environment. Thus, there is a need for a device that offers a user friendly alternative that eliminates the necessity for organic solvents and at the same time meets the highly demanding personnel safety requirements existing for any mode of biocide application.

There are known dosing systems for applying biocides in a tablet form (for example: Trichlorocyanuric acid (TCCA) & Bromochloro-5,5-dimethylhydantoin (BCDMH) tablets), such as, for example, the HAYWARD automatic pressure style chlorine feeders. Two major disadvantages of these feeders are their operation under pressure and their inability to produce a constant biocide concentration in an aqueous solution.

Other dosing systems are known, for example:

The Granudos 45/100 which is a dosing system for granular calcium hypochlorite. This device meters the chemical directly from the container (drum). The chemical is dosed into the dissolving system where it is completely dissolved with the aid of the additional metered acid and then conveyed as a highly diluted hypochloric acid to the swimming pool tubing via a venturi. This device suffers from the following disadvantages:

It has to inject acid for dissolution, using an acid tank, acid dosing pump, special tubing, and therefore has more safety hazards and storage and maintenance logistics.

It uses a mechanical screw feeder for the solids which complicates the system (e.g. need to heat solid conveying conduit to prevent condensation that causes bulking and plugging) and renders it susceptible to more frequent failure due to wear of rotating parts.

In general—the GR45/100 has a relative large footprint and weight.

The Hammonds' magnetic vortex feeder uses tablets of calcium hypochlorite to produce a solution of calcium hypochlorite having the desired biocidal strength. The vortex is generated by a free floating magnetically driven stir-bar, producing fresh batches of calcium hypochlorite solutions that are stored and ready for injection. This device suffers from the following disadvantages:

The device is suitable for large tablets only. Small granules would flow throughout the system and cause total plugging before dosing some of the granules into the water line.

The vortex control mechanism has very limited accuracy in concentration. An important parameter—the residence time of dissolving water in the dissolution chamber—is not controllable.

There is no circulation of solution from the holding tank to the dissolution chamber, so only flow-through supplies the solute, and there is no assurance or verification that the required concentration is maintained.

U.S. Pat. No. 5,468,066 patent provides an apparatus for injecting a dry particulate material into a fluid flow line comprising: (1) a mixing chamber, in which the dry particulate material is mixed with liquid; (2) a pressurized liquid supply to said mixing chamber, (3) material supply means over said mixing chamber for supplying said dry particulate material; (4) an outlet line from said mixing chamber in fluid communication with a solution of the particulate material, and (5) pump means connected to the outlet line for both exerting a vacuum in the mixing chamber and injecting mixed liquid and particulate material from the mixing chamber within said pressurized fluid flow line. This device suffers from the following disadvantages:

The solid has to free-fall into the liquid, a process associated with potential problems of plugging due to humidity, difficulty in process regulation, and solid wetting problems.

The solids are dosed by a moving mechanical drive that is prone to more rapid degradation, it is more complicated to replace and it is quite expensive.

U.S. Pat. No. 5,961,845 discloses a dispenser system for treating a water-containing system in place with a dry chemical substance. A predetermined amount of dry chemical material in a water-soluble pouch housing is dissolved in an apparatus comprising a container for obtaining a liquid chemical concentrate.

An option not feasible with this patent's design is to hold a large solid reservoir for multiple doses.

Neither of the above discussed patents and devices providing a solution to two major needs:

1. The need to wet as little biocide as possible, of a large dry matter batch, in order to prevent deactivation of the active material. In other words, it is desirable that only a small portion, preferably at the bottom of the solid particles batch, is wetted. This is in contrast to current devices in which the whole biocide batch is wetted.

2. The need to prevent small solid biocide particles from being carried-over, after their size has reduced due to dissolution.

It is an object of the present invention to provide an apparatus that dissolves particulate material, preferably solid biocide, to form solutions of a constant concentration with no decrease in the material concentration with time due to the gradual depletion of said dissolved material in the feed container. It is a further object of the present invention to provide an apparatus that dissolves solid biocide to form biocide saturated solutions with no decrease in the biocide concentration with time. It is a further object of the present invention to provide a solid-biocide dosing device that is accurate, convenient, safe, user friendly and environmentally friendly.

It is a further object of this invention to provide a dissolution setup in a way that avoids problems such as plugging/bridging and potential carryover of particulate matter. It is yet a further object of the present invention to provide a biocide dissolution system comprising the step of contacting and wetting the stationary particulate material with circulating liquid to provide a flow that contains no particulate matter (it is all dissolved). It is a further object of the present invention to provide a particular structure and shape of a solid material holding compartment to prevent plugging and agglomeration.

It is yet an additional object of the present invention to provide an automatic dosing system that doses the solid biocide directly to form a completely dissolved biocide with no need for additional materials for either pre-dissolving the solid biocide or facilitating its dissolving; such a system is easily fitted into the water treatment installation. The new apparatus improves the mode of biocide application by providing solutions of biocide having the same concentrations (doses).

According to the present invention a new device is provided for preparing biocide solutions of constant concentrations. More specifically, solid biocide is dissolved, in a controlled and monitored way, to provide solutions, all having the same and constant dose of biocide per volume. The new device overcomes the main disadvantage of the existing solid-biocide feeders, namely, the decrease in the biocide concentration with time due to the gradual depletion of solid biocide in the feed container. Furthermore, another outstanding advantage of the present invention derives from the fact that the apparatus works without potential hazardous pressure build-up in the system, in contrast to existing solid feeders, and it operates without the need for organic solvent for dissolution of relatively water-insoluble materials.

Furthermore, the unique features of the present system affords a novel approach for dissolving solid material in either batch, or continuous, modes of application, while avoiding in an inventive way major existing problems such as plugging/bridging phenomena and potential carry-over of particulate matter.

### SUMMARY OF THE INVENTION

The present invention provides a device for dissolution of a particulate material having a constant concentration of solution comprising:

(a) a particulate biocide compartment;

(b) means to supply said particulate material to said dissolution chamber, containing means for prevention of the formation of lumps which would block the descent of the solid;

(c) a dissolution chamber for dissolving the particulate material with liquid; said dissolution chamber having an inlet line for providing circulated solution of the particulate material to flow through opening(s) in its upper and lower parts to allow the solution of dissolved particulate into a solution tank;

(d) means to control the flow of particulate-free liquid;

(e) an optional screen or a sieve to prevent the particulate material from entering into the solution tank;

(f) an inlet line for adding liquid into the solution tank;

(g) means for circulating the solution of said particulate material from the solution tank to the dissolution chamber until an appropriate concentration is obtained;

(h) means for discharging the solution having the appropriate concentration of said particulate material from said tank through an outlet line; and optionally

(i) means for operation of the device in either a continuous and/or batch mode; and optionally

(j) means for automatically controlling and monitoring the device operation through a central processing unit.

### GENERAL DESCRIPTION OF THE INVENTION

The solid biocide dissolution apparatus (SBDA) of the present invention is a unique dissolution system for solid biocide applications. This novel feeding system dissolves solid biocides (for example in a compacted form, such as granules, tablets, etc.) to generate on site a fresh, aqueous saturated biocide solution to provide solutions of the same concentration (dose). The new apparatus presents a new concept in biocide application that eliminates the use of organic solvents from liquid formulations of biocides with low solubility in water and instead applies aqueous solutions of the active solid biocide. Consequently, the SBDA is a highly advanced, low cost apparatus that produces solvent-free aqueous biocide solutions of constant concentration for industrial applications, without having to monitor the disinfectant residues in the treated body of water. The device is operable with oxidizing, as well as non-oxidizing, solid biocides.

The apparatus comprises:

1. A holding compartment for the dry biocide.

2. A solution holding tank.

3. A relatively small dissolution chamber which enables limited contact of the solid biocide with the surrounding water, thus keeping the bulk of the material dry and avoiding potential decomposition.

4. An inverted cone for prevention of the formation of lumps which would block the descent of the solid from the solid holding compartment to the dissolution chamber.

5. Means for re-circulation, delivery and discharge of the saturated biocide solutions, upon demand.

The system is fully automated and controlled by a programmable logic controller (PLC) which coordinates the biocide preparation and application, and allows flexible operation of the system. A proximity sensor indicates when the solid biocide level is low.

The solid biocide can be loaded into the dissolution chamber directly from any package or, preferably, via a specially designed, disposable cartridge or closed covered package. Optional installation of an internal cutting device and connecting sleeve that enables introduction of the biocide into the system via a cartridge or a covered package, with improved safety and convenience in handling. In this mode of operation the operator has no direct contact with the biocide.

### DESCRIPTION OF THE DEVICE OF THE INVENTION

FIG. 1 demonstrates schematically the device of the present invention.

The device contains a solution holding tank or reservoir (1) for the saturated biocdide solution (or a solution having a required constant concentration of biocide), above which is situated a compartment for dry biocide (2) which has an opening in the lower side leading into an inverted cone (12) for prevention of the formation of lumps which might block the descent of the solid. Underneath the compartment for the solid biocide (2), circling the inverted cone (12) and inside the solution's container (1) is situated a dissolution chamber (3) into which is poured the solid biocide to be dissolved (only this small part of the solid is wetted by the solution). The diameter of the dissolution chamber (3) is such that the flow rate of the solution through the solid (in the area outside the inverted cone) will be low and will prevent the solid particles from floating and falling into the solution holding tank. In the upper area of the dissolution chamber are openings (4) which enable the solution passing through the solid to overflow back into the solution holding tank (1). These openings may be covered by a screen or a sieve to prevent the solid material from entering the solution tank.

In the base of the dissolution chamber (3) is connected a tube through which is entered the circulating solution through the solid biocide to obtain a saturated solution (or a solution having a required constant concentration of biocide). At the joining of the tube to the dissolution chamber (3) is situated a screen or a sieve (5) to prevent the introduction of solid particles into the pump (6).

The addition of water and circulation of the solution is automatically controlled by the following:

1. Water is added to the solution holding tank (1) through a controlling unit (7) which is connected to a central processor (11). The biocide solution is circulated until saturation or any other required concentration is achieved using a pump (6) which is operated under the control of the central processor (11). More specifically, the biocide solution is circulated a predetermined number of times via the pump (6) until a solution containing the required concentration of biocide is obtained.

2. The saturated biocide solution (or a solution having a required constant concentration of biocide) leaves the solution tank (1) via the second pump (8) towards the point of use.

The solution holding tank can be filled to any predetermined level according to the desired dose or batch size, controlled and monitored by any means of level switching high/low (LSHL) (9).

The dissolution chamber is equipped with holes through which the solution overflows to the solution holding tank. The location of the holes at the top of the dissolution chamber determines the actual amount of solid material that will be in contact with water. In other words, a different location of the holes will result in a different amount of solid that will be in contact with the aqueous solution and consequently the solution will be circulated a different number of times in order to obtain a solution of constant biocide concentration.

Means for level switch (LS) for solid level detection (10) may be installed for indication and alarm. A central processing unit (11) controls automatic operation of the predetermined sequence of solution preparation, namely, filling with water, circulating the solution for saturation, or near saturation or any other constant concentration of biocide, and discharging the biocide solution to the point of use.

An alternative approach for the use of the dissolution apparatus in a continuous mode is illustrated in FIG. 2.

In general, the basic layout of the dissolution apparatus is similar to the above mentioned and presented in FIG. 1, yet there are some changes: Water from the water source is continuously added to the apparatus through a controlling unit (that regulates the flow) into the dissolution chamber and hence to the solution holding tank (as depicted above). The saturated biocide solution (or a solution having a required constant concentration of biocide) is continuously pumped/delivered (as long as the water enters the system) from the solution holding tank (1) via a pump (8) towards the point of use. The flow of water into the apparatus is regulated in a way as to ensure the production of a saturated solution, or any required solution of constant biocide concentration.

### DESCRIPTION OF THE FIGURES

FIG. 1: A schematic description of the solid dissolution system of the present invention.

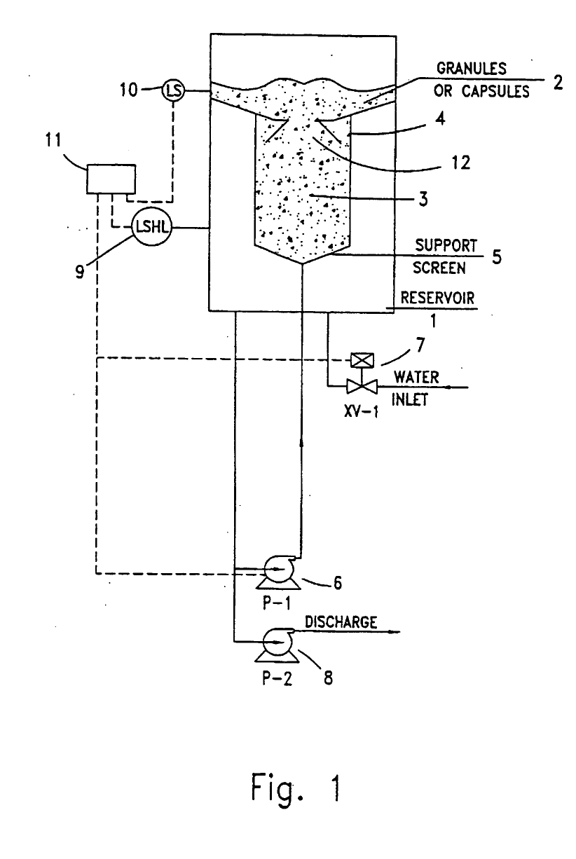

FIG. 2: A schematic description of the solid dissolution system of the present invention, for operation in a continuous mode.

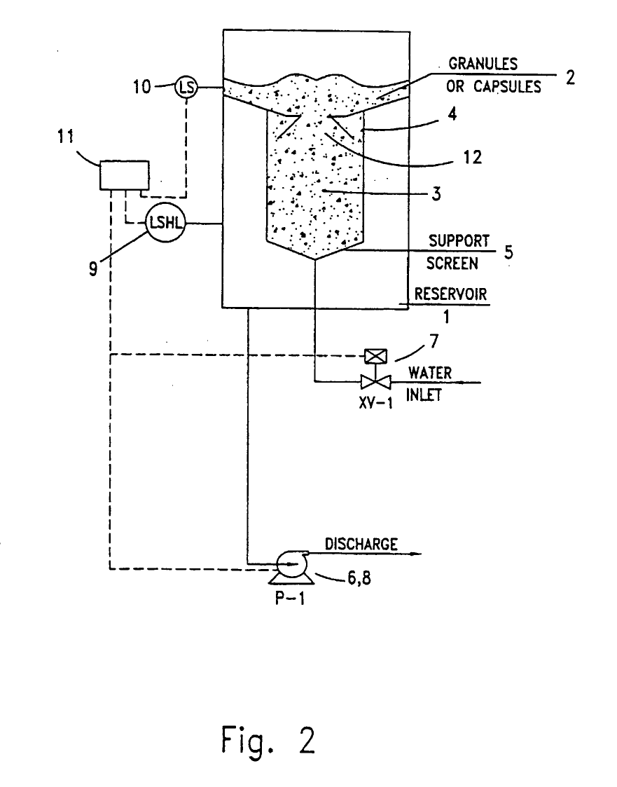

FIG. 3: Changes in DBNPA concentrations at the outlet of a conventional dissolution apparatus with time.

FIG. 4: Changes in DBNPA concentration at the outlet of a dissolution apparatus of the present invention.

FIG. 5: Counts of total bacteria and residual oxidant level (mg/l as Cl₂)

FIG. 6: A schematic description of a potential equivalent system providing a similar outcome, comprising a combination of one pump and two control valves.

### EXAMPLES

### Example 1

### Comparing DBNPA Concentrations in Solutions Prepared by a Conventional Dosing Apparatus and the Present Invention

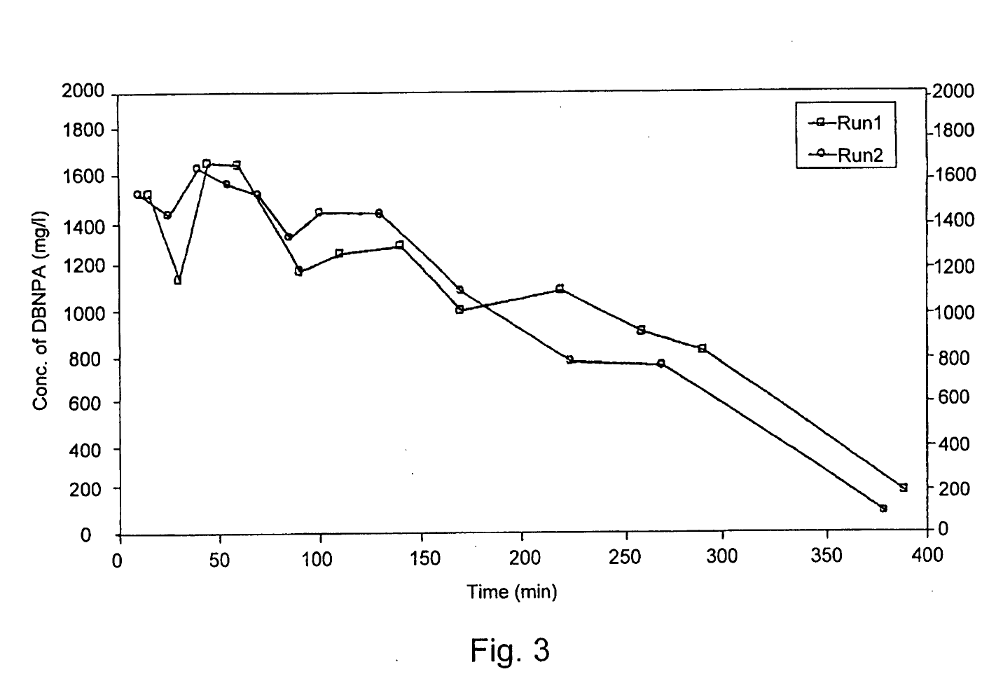

FIG. 3 presents the concentration of 2,2 Dibromo-3-nitrilopropionamide (DBNPA) in the outlet of a “conventional” dissolution apparatus as a function of time. The solid material was dissolved by passing water at a flow rate of 100 l/hour.

As can be seen, with the progression of time, DBNPA concentrations at the outlet of the apparatus decrease substantially resulting in a varying solution concentration.

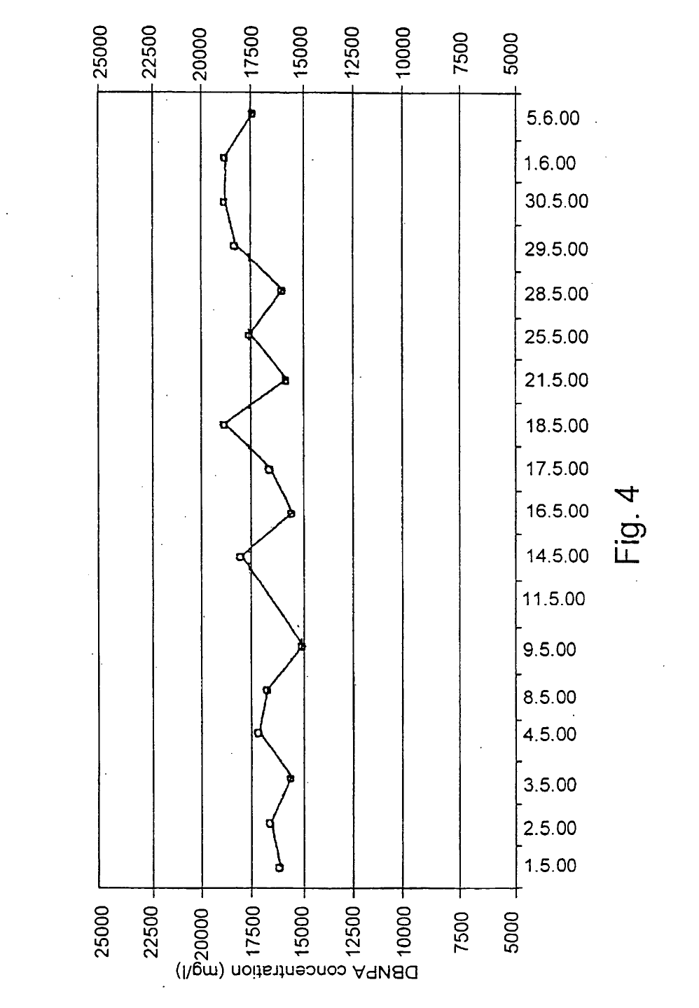

FIG. 4 describes the concentration of DBNPA in solutions prepared by the dissolution apparatus of the present invention during an actual operation trial lasting for 1 month. The solutions (a volume of 10 liters each) were prepared once a day and the DBNPA concentration was determined prior to discharge.

As can be seen, the DBNPA concentrations were stable, regardless of the amount of solid biocide in the apparatus. This may be compared to FIG. 3 which shows the decrease in concentrations of biocide in solutions prepared using the conventional methods, upon biocide depletion. The time scale in FIG. 4 represents the actual dates.

### Example 2

### A Mode of Operation of the Apparatus—A Case Study and Field Trial

The performance of the dissolution apparatus according to the present invention was demonstrated for the application of a non-oxidative biocide e.g. 2,2-dibromo-3-nitrilopropionamide (DBNPA).

(A) Test Site: The test was conducted in a cooling tower located on the shores of the Mediterranean Sea. The 8 m³ cooling tower has a daily makeup of approximately 20 m³, and a concentration ratio that ranged between 6-10. Typical pH values for the cooling water ranged from 8.5-8.8. A portion of the re-circulated water was filtered through a disk filter. The ambient temperatures during the trial were 25-30° C.

(B) Device Operation:

1. Installation:

1.1 The apparatus was placed within 2 meters of the treated tower.

1.2 The apparatus was secured firmly to prevent tilting during operation.

1.3 The apparatus was connected to a water main (as a water source), to a power source (220V, AC), and the outlet of the apparatus was connected via flexible tubing to the tower basin in a way as to prevent siphoning of the water back to the apparatus.

2. Operation:

2.1 The apparatus was filled with solid DBNPA (20 Kg. of tablets) through the filling port at the top of the apparatus, from a conventional biocide bucket.

2.2 The volume of biocide solution was 10 liters. It was determined according to tower volume and dosing regime. The volume was set by positioning the water volume electrode in the proper position.

2.3 The operational parameters were fed into the PLC controller and the apparatus became operative.

2.4 The sequence of events upon operation was as follows:

2.4.1 At the pre-set time the PLC operated an electronic faucet, which allowed for the pre-determined volume of water (10 liters) to fill the apparatus. The filling time was in the range of 1-1.5 min.

2.4.2 After filling with the appropriate volume of water the system began to circulate the water for a pre-set time (60 min and then the prepared saturated solution (typical concentrations ranged from 15,000 to 17,000 mg/l) was delivered to the treated tower. The delivery time was 2 min.

2.4.3 After the operating cycle the apparatus was idle until the next scheduled operation sequence.

2.4.4 The entire operation sequence continued in this case for 65 min.

(C) DBNPA Application Mode:

The tower was treated with a daily slug (23 mg/l) of an aqueous DBNPA solution generated by the solid biocide dissolution apparatus of the present invention, using DBNPA tablets as the solid biocide source.

The DBNPA solution added to the tower was saturated. The amount of solution added was such that it created a final concentration of 23 mg/l upon addition to the tower.

(D) Microbiological Control:

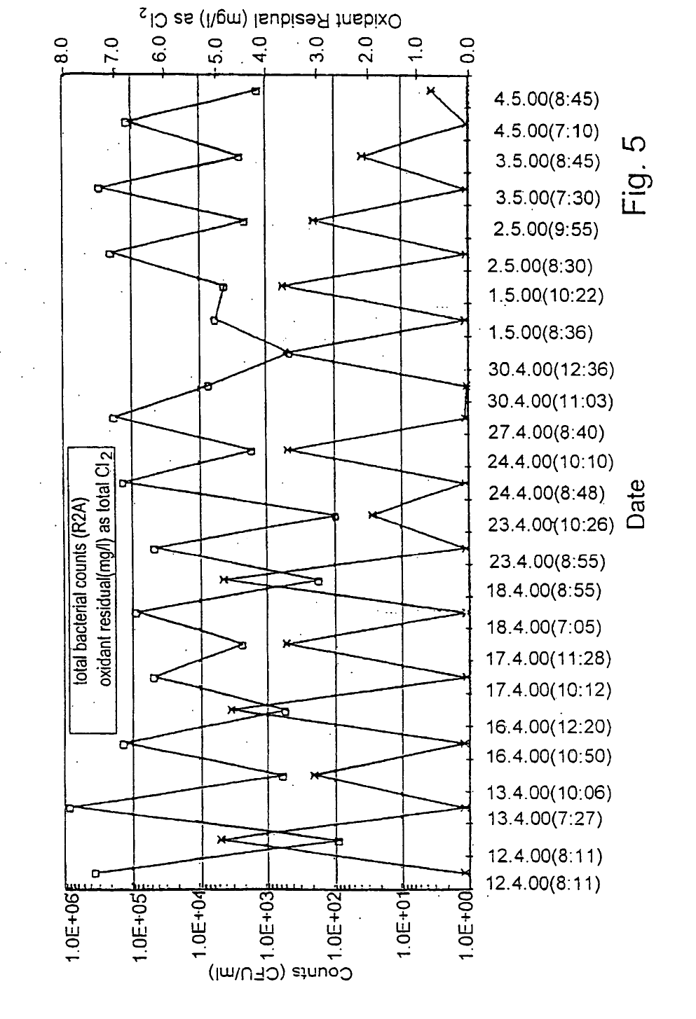

Counts of total bacteria and residual oxidant level (mg/l as Cl₂) measured during the trial are presented in FIG. 5. The convenient method to determine the DBNPA concentration under field conditions is by using the dialkyl-p-phenylenediamine (DPD) method. This method is the conventional method for the determination of residual oxidant levels. Although DBNPA is a non-oxidizing biocide, it was demonstrated that its concentration could be followed by the DPD method based on a calibration curve.

The data reflect the measurements prior to the addition of the daily slug dose (23 mg/l) that was prepared in the solid biocide dissolution apparatus of the present invention, and 60 minutes after the DBNPA solution was added to the tower. The results (presented in FIG. 5) show that before the addition of the daily slug dose, the residual oxidant was zero and the bacterial counts averaged at 1×10⁵ CFU/ml.

After the addition of the daily dose (after 60 minutes), the residual oxidant in the water was high and the concentration of bacteria decreased substantially. The mean bacterial concentration (obtained 24 hours after the last addition of DBNPA dose on the previous day) was ca. 1×10⁵ CFU/ml, which is acceptable in such a treatment regime.

The results of the field trial showed that the dissolution apparatus performed well for the duration of the trial (two months) in terms of technical performance and the DBNPA solution properties. DBNPA solutions were practically saturated and concentrations were constant. The DBNPA tablets used during the trial period were consumed continuously and no mechanical obstacles were observed in terms of tablet delivery from the storage compartment to the dissolution chamber.

The microbiological results showed that bacterial control was maintained throughout the experiment despite the high pH range in which the tower operated.

### Example 3

### Operation of the Apparatus in a Continuous Mode

The solid biocide dissolution system was operated continuously in accordance with the previously described mode of continuous operation. The system was operated with varying flow rates and the results were as follows:

| | DBNPA |
|---|---|
| | concentration |
| Flow (l/h) | (mg/l) |
| 50 | 16725 ± 277 |
| 75 | 15075 ± 433 |
| 100 | 14870 ± 843 |
| 150 | 14535 ± 1661 |
| 200 | 12190 ± 1348 |
| 250 | 12270 ± 986 |
| 300 | 10981 ± 602 |

The results represent an average of 5 samples drawn within 30 minutes of operation at the designated flow.

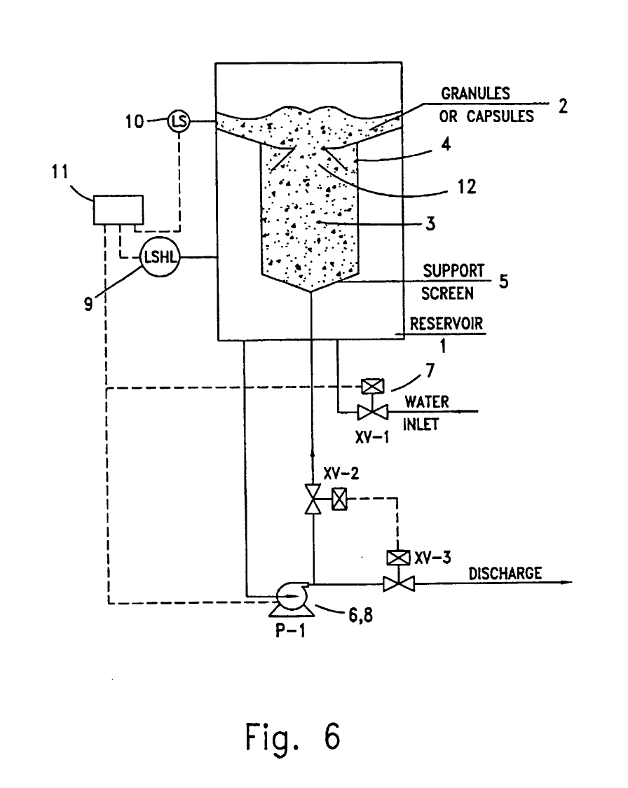

The foregoing disclosure and description of the invention is merely illustrative and explanatory thereof. Various changes in the details of the illustrated configuration and mode of operation may be made by a person skilled in the art within the scope of the invention, without departing from the true spirit of it. Thus, the same principle and outcome can be obtained with other combinations of pumps, venturi based devices and control valves or other means. For example, a similar outcome was obtained by a combination of one pump and two control valves as described in FIG. 6.

1. A device for dissolution of a particulate material to provide a constant concentration of solution comprising:
(a) a particulate biocide compartment;
(b) means to supply said particulate material to said dissolution chamber, containing means for prevention of the formation of lumps which would block the descent of the solid;
(c) a dissolution chamber for dissolving the particulate material with liquid; said dissolution chamber having an inlet line for providing circulated solution of the particulate material to flow through opening(s) in its upper and lower parts to allow the solution of dissolved particulate into a solution tank;
(d) means to control the flow of particulate-free liquid;
(e) an optional screen or a sieve to prevent the particulate material from entering into the solution tank;
(f) an inlet line for adding liquid into the solution tank;
(g) means for circulating the solution of said particulate material from the solution tank to the dissolution chamber until an appropriate concentration is obtained;
(h) means for discharging the solution having the appropriate concentration of said particulate material from said tank through an outlet line; and optionally
(i) means for operation of the device in either a continuous and/or batch mode; and optionally
(j) means for automatically controlling and monitoring the device operation through a central processing unit.

2. A device according to claim 1, for dissolution of a particulate material to provide a saturated solution.

3. A device according to claim 1, for dissolution of a particulate material to provide a near-saturated solution.

4. A device according to claim 1, for dissolution of a particulate material to provide a solution with a constant concentration.

5. A device according to any of claims 1 to 4 containing means for loading of the solid material via a specially designed disposable cartridge or closed covered package, while minimizing the exposure of operators to the applied solid material.

6. A device for dissolution of a particulate material according to any of claims 1 to 5 wherein the various components can be installed in one or several units, according to the field requirements.

7. A device according to any of claims 1 to 6, wherein means for supplying particulate material to the said dissolution chamber comprises a removable (detachable) rigid container connected in its lower part to the dissolution chamber and contains any desired amount of particulate material which moves freely from the container to the dissolution chamber.

8. Means for supplying particulate material to the dissolution chamber according to claim 7, comprising means for LS solid level detection for indicating the amount of particulate material left and for alarm.

9. A device according to any of claims 1 to 8, wherein said solution tank has a predetermined liquid therein and means to control and monitor the liquid at the desired level.

10. A solution tank according to claim 9, wherein liquid level is monitored and controlled by any means of LSHL level switching.

11. A device according to any of claims 1 to 10, wherein said liquid is water.

12. A device according to any of claims 1 to 11, wherein the particulate material has biocidal properties.

13. A device according to any of claims 1 to 12, wherein the particulate material is 2,2-dibromo-3-nitrilopropionamide (DBNPA).

14. A device according to claim 1, wherein an inverted cone prevents the formation of lumps which may block the descent of the solid.

15. A device according to claim 1, wherein the physical dimensions of the dissolution chamber allow for a flow regime that prevents carry over of particulate matter to the solution tank.

16. A device according to claim 1, wherein sieved openings in the dissolution chamber have holes impermeable to the particulate material thus preventing its free release from the dissolution chamber.

17. A method for continuous dissolution of a particulate material in a liquid to obtain a constant concentration of solution, using a device for dissolution, according to claim 1.

18. A method for continuous dissolution of a particulate material in a liquid to obtain a saturated solution, using a device for dissolution, according to claim 1.

19. A method for continuous dissolution of a particulate material in a liquid to obtain a near-saturated solution, using a device for dissolution, according to claim 1.

20. A method for batch dissolution of a particulate material in a liquid to obtain a constant concentration of solution, using a device for dissolution, according to claim 1.

21. A method for batch dissolution of a particulate material in a liquid to obtain a saturated solution, using a device for dissolution, according to claim 1.

22. A method for batch dissolution of a particulate material in a liquid to obtain a near-saturated solution, using a device for dissolution, according to claim 1.

23. A method for continuous dissolution of a particulate material, according to claims 17-19, wherein the dissolved material is a biocide.

24. A method for batch dissolution of a particulate material according to claims 20-22, wherein the dissolved material is a biocide.
